(19) United States
(12) Patent Application Publication
(10) Pub. No.: US 2007/0022176 A1
(43) Pub. Date: Jan. 25, 2007

(54) Switching device for remotely controlling connections of a computer and peripherals over networks

(75) Inventor: Mitsuru Kobayashi, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 11/397,694

(22) Filed: Apr. 5, 2006

(30) Foreign Application Priority Data
Jul. 22, 2005 (JP) 2005-212472

(51) Int. Cl. G06F 15/16

(52) U.S. Cl. 709/217; 340/3.7; 715/718

(57) ABSTRACT

A switching device making it possible to manipulate a computer, which is installed on a local side, at a remote-control side over networks has a remote manipulation notification unit. When the computer is manipulated at the remote-control side, the remote manipulation notification unit notifies the local side, on which the computer is installed, of the manipulation of the computer performed at the remote-control side.

### CROSS REFERENCE TO RELATED APPLICATION

This application is based upon and claims the benefit of priority from the prior Japanese Patent Application No. 2005-212472, filed on Jul. 22, 2005, the entire contents of which are incorporated herein by reference.

### BACKGROUND OF THE INVENTION

1. Field of the Invention

The present invention relates to a switching device, and a control method and a control program for the switching device. More particularly, the present invention is concerned with a switching device (KVM remote-control device) that remotely controls connections of a computer and peripherals (mainly a keyboard (K), a video monitor (V), and a mouse (M)) over networks.

2. Description of the Related Art

In the past, a KVM switch has been utilized as a switching device making it possible to manipulate a plurality of computers using one set of a keyboard (K), a video monitor (V), and a mouse (M). Furthermore, an IP-KVM switch remotely controllable through Internet Protocol (IP) routing has been developed these days.

Along with the recent growth in networks which is observed in the Internet, the importance of computers such as servers and personal computers that support the Internet is increasing. If the computers fail, provision of services could be suspended to seriously affect the world.

In order to keep the computers including servers and personal computers stably operational, daily maintenance is needed. For example, if a server fails or when the maintenance of computers is required, engineers must repair or maintain the computers.

However, a mechanism for remotely maintaining a computer, such as a server or a personal computer, is demanded because the repair or maintenance by an engineer is time-consuming and costly. A suitable device to solve the problem is a so-called extended-over-IP-KVM switch (KVM remote-control device). In the present specification, devices including the so-called extended-over-IP-KVM switch will be referred to as IP-KVM switches.

The IP-KVM switch is intended to allow a user to manipulate a keyboard, a mouse, and a video monitor included in a computer located in a remote place as if the user were near the keyboard, mouse, and video monitor. Networks including the Internet and a local area network (LAN) are adopted as communication means. A switching device in accordance with the present invention is intended mainly to facilitate the use of the IP-KVM switch.

Japanese Unexamined Patent Publication (Kokai) No. 2000-286873 has disclosed a network management system that makes it possible to manage a plurality of compact terminals, which is dedicated to a network and devoid of a network management feature, at a server within a system in which the compact terminals dedicated to a network and each including a display unit and an audio output unit are interconnected over the network.

Furthermore, Japanese Unexamined Patent Publication (Kokai) No. 2003-153033 has disclosed a system and a method for remotely controlling a personal computer that controls home audiovisual facilities which include, for example, a radio receiver, a compact disk (CD) player, a pair of loudspeakers, a television set, a video cassette recorder (VCR), and a videotape recorder.

Moreover, Japanese Unexamined Patent Publication (Kokai) No. 2003-280777 has disclosed as a switching device, which makes it easy to recognize a connection between an input terminal and an output terminal without sacrificing convenience, a switching device including a display unit that can display character data, and a control unit that causes the display unit to display character data, which signifies the connection between an input terminal and an output terminal, responsive to switching of the input and output terminals.

Furthermore, Japanese Unexamined Patent Publication (Kokai) No. 2005-044198 has disclosed a signal processing apparatus, a remote-control system, a signal processing method, and a signal processing program which make it possible to remotely manipulate a server connected to personal computers over a network (LAN) and which facilitate system configuration and management.

The prior art and its associated problems will be described later with reference to the accompanying drawings.

### SUMMARY OF THE INVENTION

An object of the present invention is, when a computer to be manipulated which is located on a local side is manipulated at a remote-control side over networks, to notify the local side, on which the computer to be manipulated is located, of the manipulation performed at the remote-control side so as to prevent an incorrect manipulation of the computer to be manipulated, and to thus minimize the number of malfunctions of the computer to be manipulated.

According to the present invention, there is provided a switching device making it possible to manipulate a computer, which is installed on a local side, at a remote-control side over networks, comprising a remote manipulation notification unit, when the computer is manipulated at the remote-control side, notifying the local side, on which the computer is installed, of the manipulation of the computer performed at the remote-control side.

The remote manipulation notification unit may include a first displaying notification portion notifying the manipulation of the computer, which is performed at the remote-control side, using a display screen of a display device included in the computer. The first displaying notification portion may notify the manipulation of the computer, which is performed at the remote-control side, using characters or an image through on-screen display on the display screen of the computer. The first displaying notification portion may notify the manipulation of the computer, which is performed at the remote-control side, by displaying a dialog box or the like on the display screen of the computer.

The remote manipulation notification unit may include a first sounding notification portion notifying the manipulation of the computer, which is performed at the remote-control side, using a sounding body included in the computer. The first sounding notification portion may notify the manipulation of the computer, which is performed at the remote-control side, using music or voice output from a buzzer or a loudspeaker included in a computer body.

The remote manipulation notification unit may include a first displaying notification portion notifying the manipulation of the computer, which is performed at the remote-control side, using a display screen of a display device included in the computer; and a first sounding notification portion notifying the manipulation of the computer, which is performed at the remote-control side, using a sounding body included in the computer.

The remote manipulation notification unit may include a second displaying notification portion notifying the manipulation of the computer, which is performed at the remote-control side, using a display unit included in the switching device. The second display notification portion may have a lamp or an LCD included in the switching device.

The remote manipulation notification unit may include a second sounding notification portion notifying the manipulation of the computer, which is performed at the remote-control side, using a sounding body included in the switching device. The second sounding notification portion may have a buzzer or a loudspeaker included in the switching device.

The remote manipulation notification unit may include a second displaying notification portion notifying the manipulation of the computer, which is performed at the remote-control side, using a display unit included in the switching device; and a second sounding notification portion notifying the manipulation of the computer, which is performed at the remote-control side, using a sounding body included in the switching device.

The remote manipulation notification unit may include a first displaying notification portion notifying the manipulation of the computer, which is performed at the remote-control side, using a display screen of a display device included in the computer; a first sounding notification portion notifying the manipulation of the computer, which is performed at the remote-control side, using a sounding body included in the computer; a second displaying notification portion notifying the manipulation of the computer, which is performed at the remote-control side, using a display unit included in the switching device; and a second sounding notification portion notifying the manipulation of the computer, which is performed at the remote-control side, using a sounding body included in the switching device.

The remote manipulation notification unit may include an interface via which the manipulation of the computer performed at the remote-control side is communicated to each of the switching device and a notification device located outside the computer. The notification device may notify the manipulation of the computer, which is performed at the remote-control side, by lighting or blinking a signal lamp, which is disposed on the local side, via the interface included in the switching device.

The notification device may notify the manipulation of the computer, which is performed at the remote-control side, using a portable cellular phone, which is disposed on the local side, via the interface included in the switching device. A power supply of the computer may be controlled by manipulating the power supply from the remote-control side via the interface.

The remote manipulation notification unit may notify the manipulation of the computer, which is performed at the remote-control side, during a predetermined period of time or an arbitrary period of time. When the computer is manipulated at the local side, the remote manipulation notification unit may suspend a notification of the manipulation of the computer performed at the remote-control side. The networks may be IP networks and the switching device may be an IP-KVM switch.

Further, according to the present invention, there is provided a control method for a switching device making it possible to manipulate a computer, which is installed on a local side, at a remote-control side via networks, wherein when the computer is manipulated at the remote-control side, the local side on which the computer is installed is notified of the manipulation of the computer performed at the remote-control side.

In addition, according to the present invention, there is also provided a control program for a switching device that makes it possible to manipulate a computer, which is installed on a local side, at a remote-control side over networks, and that when the computer is manipulated at the remote-control side, notifies the local side, on which the computer is installed, of the manipulation of the computer performed at the remote-control side, wherein the control program makes the computer to notify the manipulation of the computer, which is performed at the remote-control side, using a display screen of a display device included in the computer or by outputting a sound from the computer.

### BRIEF DESCRIPTION OF THE DRAWINGS

The present invention will be more clearly understood from the description of the preferred embodiments as set forth below with reference to the accompanying drawings, wherein:

FIG. 1 is a block diagram schematically showing an example of a conventional IP-KVM switch;

FIG. 2 is a block diagram schematically showing a first embodiment of a switching device in accordance with the present invention;

FIG. 3 is a block diagram schematically showing a second embodiment of a switching device in accordance with the present invention;

FIG. 4 is a block diagram schematically showing a third embodiment of a switching device in accordance with the present invention;

FIG. 5 is a block diagram schematically showing a fourth embodiment of a switching device in accordance with the present invention;

FIG. 6 is a block diagram schematically showing a fifth embodiment of a switching device in accordance with the present invention;

FIG. 7 is a block diagram schematically showing a sixth embodiment of a switching device in accordance with the present invention;

FIG. 8 is a block diagram schematically showing a seventh embodiment of a switching device in accordance with the present invention;

FIG. 9 is a block diagram schematically showing an eighth embodiment of a switching device in accordance with the present invention; and

FIG. 10 is a block diagram schematically showing a ninth embodiment of a switching device in accordance with the present invention.

### DESCRIPTION OF THE PREFERRED EMBODIMENTS

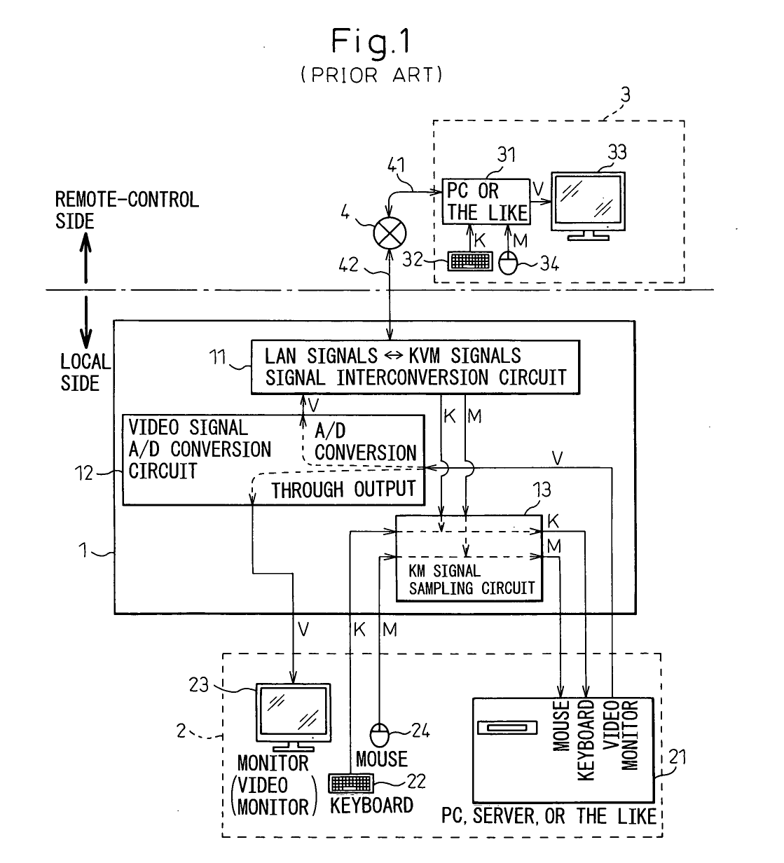

Before describing in detail the preferred embodiments of the present invention, a conventional switching device and its underlying problems will be mentioned with reference to FIG. 1.

FIG. 1 is a block diagram schematically showing an example of a conventional IP-KVM switch. Referring to FIG. 1, there are shown a switching device 1 (IP-KVM switch), a computer to be manipulated (local computer) such as a server or a personal computer that is an object of manipulation, and equipment 3 to be manipulated in a remote place (remote-control computer).

As shown in FIG. 1, the remote-control computer 3 is installed on a remote-control side. The remote-control computer 3 includes a computer body 31, a keyboard (K) 32, a video monitor (V) 33, and a mouse (M) 34. The remote-control computer 3 is connected to the IP-KVM switch 1 on the local side over LANs 41 and 42 implemented based on the Ethernet® and the Internet 4.

On the local side, the IP-KVM switch 1 and the local computer 2 connected to the IP-KVM switch 1 are installed. The local computer 2 is, for example, a server that provides network services and includes a computer body 21, a keyboard (K) 22, a video monitor (V) 23, and a mouse (M) 24.

The IP-KVM switch 1 includes a signal interconversion circuit 11, a video signal A/D conversion circuit 12, and a KM signal sampling circuit 13. The video signal A/D conversion circuit 12 passes a video monitor signal (V signal) sent from the computer body 21 included in the local computer 2, and supplies it to the video monitor 23 included in the local computer 2. Moreover, the video signal A/D conversion circuit 12 analog-to-digital converts the video monitor signal and transmits a digital V signal to the signal interconversion circuit 11.

The KM signal sampling circuit 13 samples a keyboard signal (K signal) sent from the keyboard 22 included in the local computer 2 and a mouse signal (M signal) sent from the mouse 24 included therein, and also samples a K signal and an M signal sent from the signal interconversion circuit 11 (that is, a K signal sent from the keyboard 32 included in the remote-control computer 3 over the networks and an M signal sent from the mouse 34 included therein). The KM signal sampling circuit 13 then supplies the sampled signals to the computer body 21 of the local computer 2. Furthermore, the signal interconversion circuit 11 converts LAN signals such as Ethernet® signals sent over the LAN 42 to KVM signals or vice versa.

When the local computer 2 is remotely manipulated at the remote-control computer 3, the IP-KVM switch 1 transfers a K signal, which is sent from the keyboard 32 included in the remote-control computer 3 over the networks 41, 4, and 42, and an M signal, which is sent from the mouse 34 included therein, to the computer body 21 included in the local computer 2. Moreover, the IP-KVM switch 1 transfers a V signal, which is sent from the computer body 21 included in the local computer 2, to the video monitor 33 included in the remote-control computer 3 over the networks 42, 4, and 41.

Specifically, an operator on the remote-control side can remotely manipulate the local computer 2 via the IP-KVM switch 1 over the networks 41, 4, and 42. As the local computer 2 includes the keyboard 22, video monitor 23, and mouse 24, an operator on the local side can directly manipulate the local computer 2. The operator on the remote-control side remotely manipulates the local computer 2 through, for example, a graphical user interface (GUI) at the remote-control computer 3.

As mentioned above, conventionally, an operator in a remote place uses the IP-KVM switch 1, which is manipulated through a GUI, to remotely manipulate the local computer 2 such as a server or a personal computer, which is located on a local side, at the remote-control computer 3 in the remote place. However, when the local computer 2 is remotely manipulated at the remote place, if a visible action such as a keystroke or a manipulation of a mouse is not performed, the operator on the local side on which the local computer 2 is actually installed may directly and locally manipulate the local computer 2.

To be more specific, when, for example, batch processing of files that does not appear on the screen of the video monitor 23 included in the local computer 2 is remotely controlled, if the operator on the local side manipulates the local computer 2, it is very dangerous because, at worst, shutdown may occur or breakdown of a hard disk or deletion of a file may stem from restart.

Moreover, even when the local computer is not remotely manipulated at the remote place, if a means (unit) for notifying the operator on the local side of the fact that the settings of the local computer 2 have been modified at the remote-control computer 3 in the remote place is unavailable, the operator on the local side who starts the local computer 2 and who does not recognize the fact that the settings have been modified may incorrectly manipulate the local computer.

Embodiments of a switching device and a control method and a control program for the switching device in which the present invention is implemented will be described below with reference to the appended drawings.

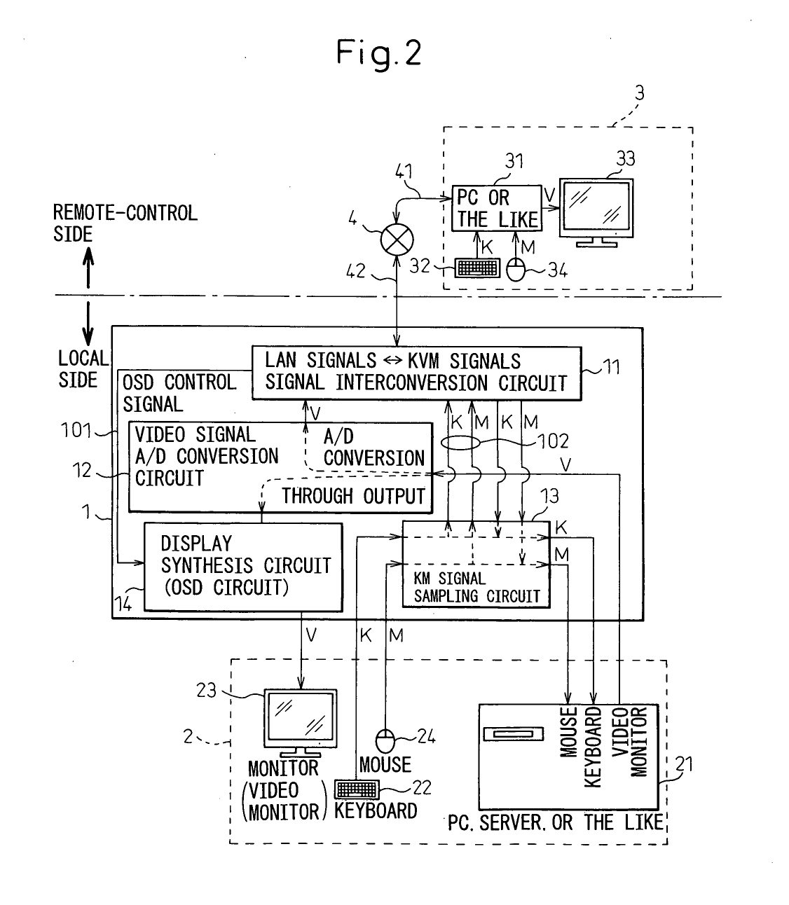

FIG. 2 is a block diagram schematically showing a first embodiment of a switching device in accordance with the present invention. Referring to FIG. 2, there are shown a switching device (IP-KVM switch) 1, a computer 2 to be manipulated (local computer) such as a server or a personal computer (PC) that is an object of manipulation, and equipment 3 to be manipulated in a remote place (remote-control computer).

As apparent from the comparison of FIG. 2 with FIG. 1, the first embodiment includes, in addition to the same components as those of the conventional IP-KVM switch shown in FIG. 1, a display synthesis circuit (on-screen display (OSD) circuit) 14. The configuration of the remote-control computer 3 on the remote-control side and the configuration of the local computer 2 on the local side are substantially identical to the ones described with reference to FIG. 1.

Specifically, the remote-control computer 3 includes a computer body 31, a keyboard (K) 32, a video monitor (V) 33, and a mouse (M) 34, and is connected to an IP-KVM switch 1 on the local side over LANs 41 and 42 and the Internet 4. Moreover, the local computer 2 is connected to the IP-KVM switch 1, and includes a computer body 21, a keyboard (K) 22, a video monitor (V) 23, and a mouse (M) 24. The local computer 2 is, for example, a server that provides network services.

As shown in FIG. 2, the IP-KVM switch 1 in accordance with the first embodiment includes a signal interconversion circuit 11, a video signal A/D conversion circuit 12, a KM signal sampling circuit 13, and an OSD circuit 14. The video signal A/D conversion circuit 12 passes a video monitor signal (V signal) sent from the computer body 21 included in the local computer 2, and supplies the V signal to the video monitor 23 of the local computer 2. Moreover, the video signal A/D conversion circuit 12 analog-to-digital converts the V signal and transmits the resultant digital signal to the signal interconversion circuit 11.

The KM signal sampling circuit 13 samples a keyboard signal (K signal) sent from the keyboard 22 included in the local computer 2, a mouse signal (M signal) sent from the mouse 24 included therein, and K and M signals sent from the signal interconversion circuit 11 (that is, a K signal sent from the keyboard 32 included in the remote-control computer 3 over the networks and an M signal sent from the mouse 34 included therein). The KM signal sampling circuit 13 then supplies the sampled signals to the computer body 21 of the local computer 2. The signal interconversion circuit 11 converts, for example, LAN signals sent over the LAN 42 into KVM signals or vice versa.

As mentioned previously, when the local computer 2 is remotely manipulated at the remote-control computer 3, the IP-KVM switch 1 transfers a K signal, which is sent from the keyboard 32 included in the remote-control computer 3 over the networks 41, 4, and 42, and an M signal, which is sent from the mouse 34 included therein, to the computer body 21 of the local computer 2. Moreover, the IP-KVM switch 1 transfers a V signal, which is sent from the computer body 21 of the local computer 2, to the video monitor 33 of the remote-control computer 3 over the networks 42, 4, and 41. Consequently, the operator on the remote-control side can remotely manipulate the local computer 2 via the IP-KVM switch 1 over the networks 41, 4, and 42.

In the IP-KVM switch 1 of the first embodiment, an OSD control signal 101 sent from the signal interconversion circuit 11 is supplied to the OSD circuit 14. When the local computer 2 is controlled using the remote-control computer 3, a message saying, for example, “Currently, the local computer 2 is being manipulated using the remote-control computer 3.” is displayed on the screen of the video monitor 23 included in the local computer 2.

Herein, a content to be displayed on the video monitor 23 of the local computer 2 is not limited to the above message. Alternatively, various characters or images (graphics) may be displayed. The characters or image may be displayed, for example, during a predetermined period of time or an arbitrary period of time.

In the IP-KVM switch 1 of the first embodiment, K and M signals 102 are transferred from the KM signal sampling circuit 13 to the signal interconversion circuit 11. Thus, the fact that the keyboard 22 or mouse 24 of the local computer 2 has been manipulated is recognized. The OSD circuit 14 deletes the display of a message or the like from the video monitor 23 in response to an OSD control signal 101 sent from the signal interconversion circuit 11. Consequently, the message or the like will not interrupt the operator on the local side who is manipulating the local computer 2 while recognizing the fact that the local computer is being remotely manipulated at the remote-control computer 3.

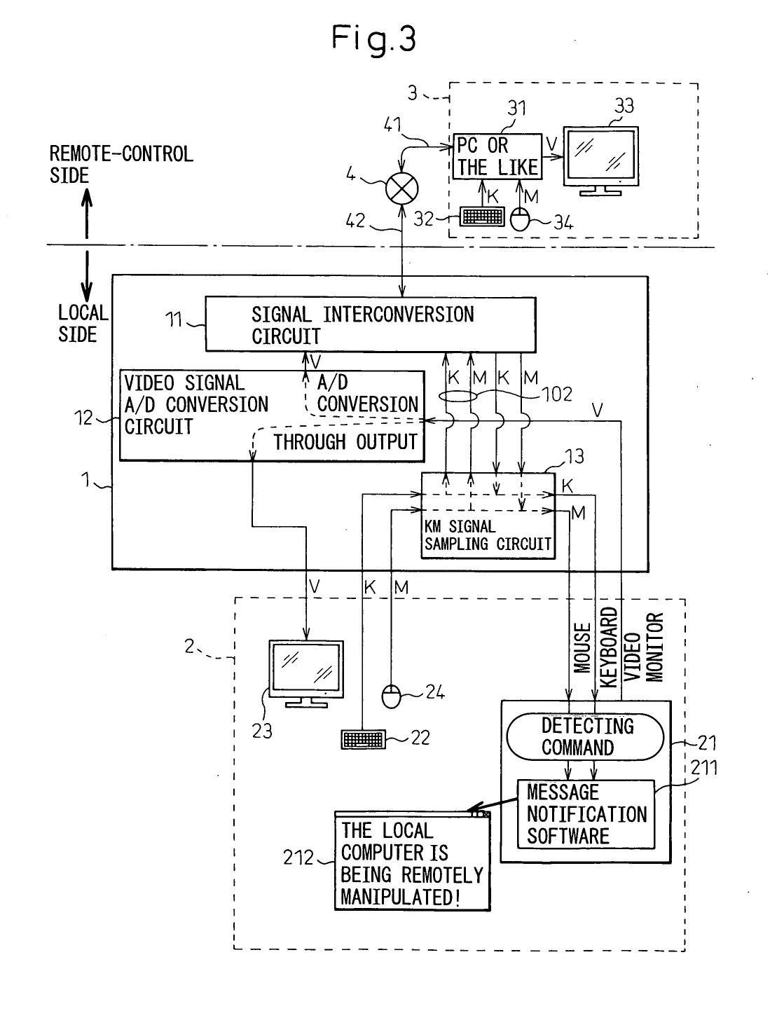

FIG. 3 is a block diagram schematically showing a second embodiment of a switching device in accordance with the present invention.

As shown in FIG. 3, according to the second embodiment, message notification software (and driver software) 211 is installed in the local computer 2 (computer body 21) in advance. When the local computer 2 is remotely manipulated at the remote-control computer 3, a message display command sent while being mixed with a K or an M signal is detected, and a message 212 signifying that the local computer 2 is being remotely manipulated, for example, is displayed in a dialog box.

The message display command is mixed with a keyboard (K) signal or a mouse (M) signal by, for example, an MPU included in the interconversion circuit 11, and is supplied to the local computer 2 via the KM signal sampling circuit 13. Incidentally, a period of time during which the message is displayed may be a certain period of time or an arbitrary period of time. Even in the IP-KVM switch 1 of the second embodiment, similarly to the first embodiment, when the K and M signals 102 sent from the KM signal sampling circuit 13 are transferred to the signal interconversion circuit 11 and the keyboard 22 or mouse 24 of the local computer 2 is manipulated, a message deletion command is transmitted to the local computer 2.

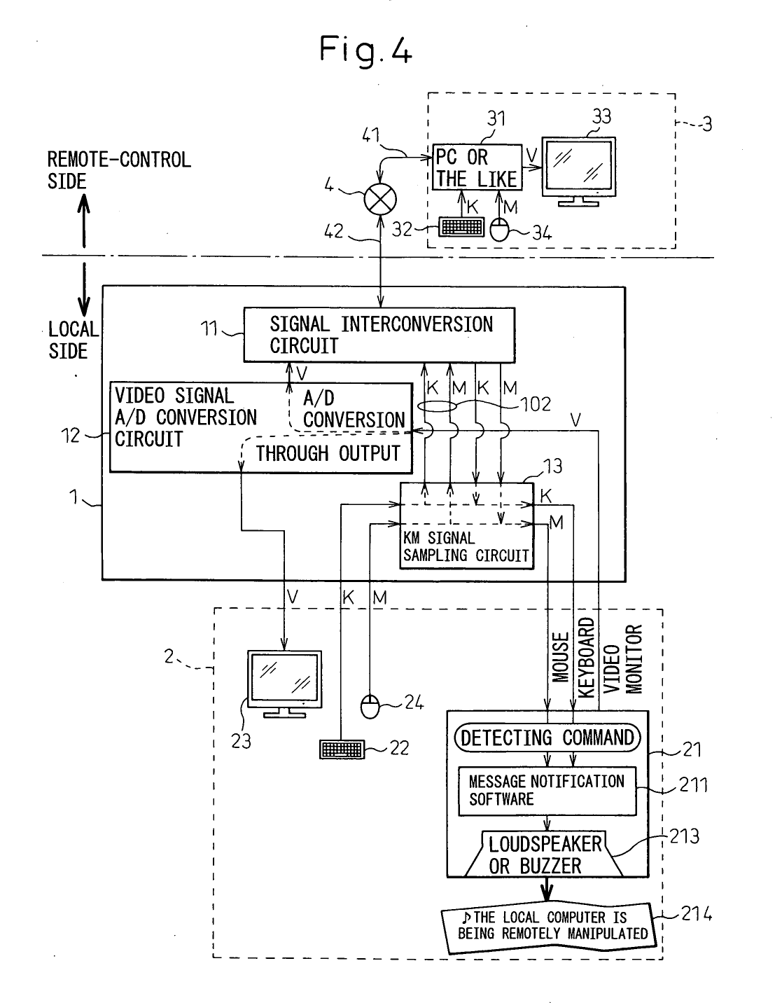

FIG. 4 is a block diagram schematically showing a third embodiment of a switching device in accordance with the present invention.

As shown in FIG. 4, the third embodiment is different from the second embodiment in a point that what is notified by the message notification software 211 is not the message 212 such as a dialog box but is, for example, a buzzer sound, music, or voice 214 output from a loudspeaker 213 included in the computer body 21.

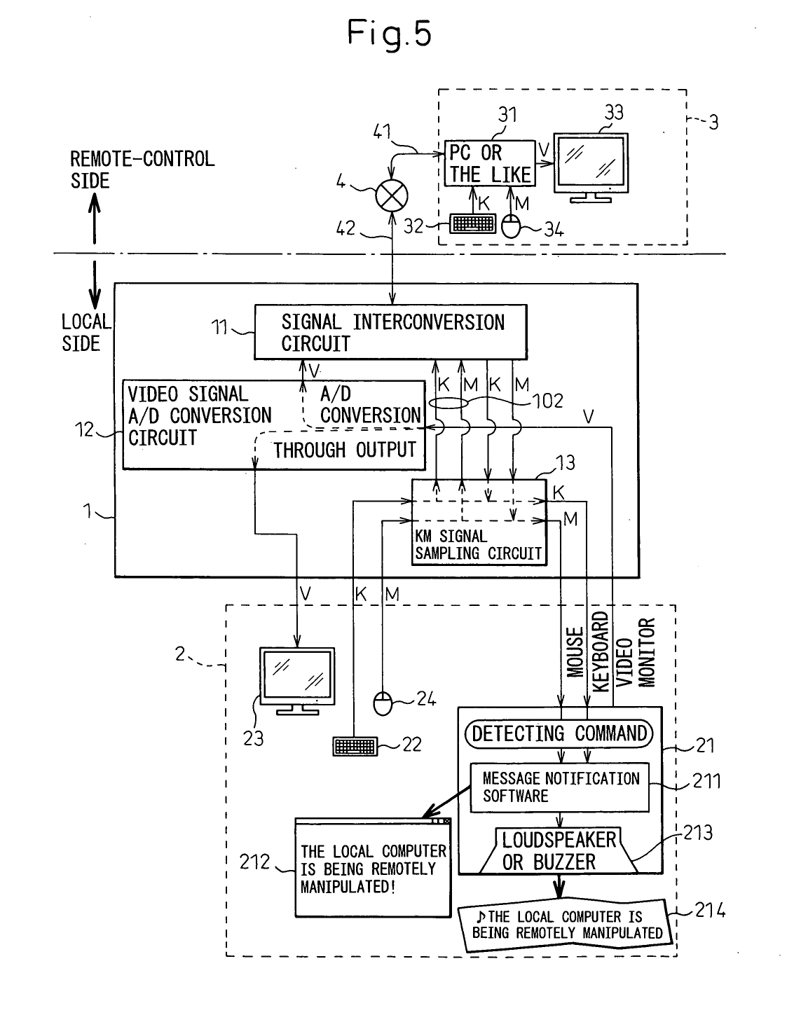

FIG. 5 is a block diagram schematically showing a fourth embodiment of a switching device in accordance with the present invention.

The fourth embodiment shown in FIG. 5 is equivalent to a combination of the second and third embodiments. The fact that the local computer 2 is being remotely manipulated at the remote-control computer 3 is notified by displaying the message 212 such as a dialog box and outputting a buzzer sound, music, or voice 214 from the loudspeaker 213 included in the computer body 21.

In the third and fourth embodiments, when the keyboard 22 or mouse 24 of the local computer 2 is manipulated, the notification with the message 212 such as a dialog box and the buzzer sound, music, or voice 214 is suspended so as not to interrupt the operator's manipulation performed on the local side.

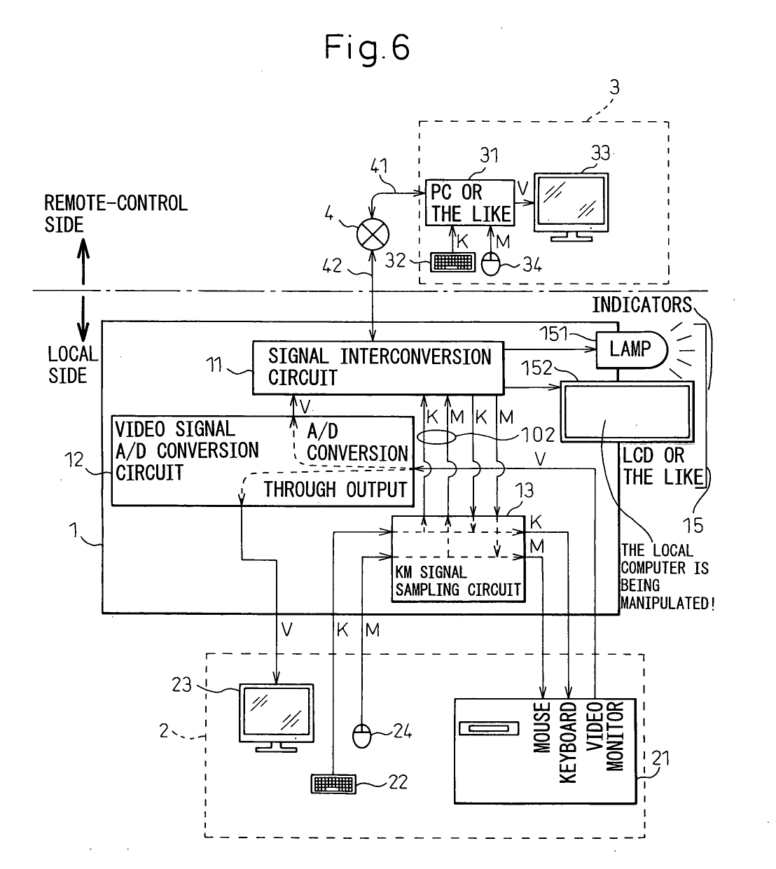

FIG. 6 is a block diagram schematically showing a fifth embodiment of a switching device in accordance with the present invention.

As shown in FIG. 6, the IP-KVM switch 1 in accordance with the fifth embodiment includes indicators 15 such as a lamp 151 and a liquid crystal display (LCD) 152. The indicators 15 included in the IP-KVM switch 1 itself are used to notify the fact that the local computer 2 is remotely manipulated at the remote-control computer 3.

Specifically, when the local computer 2 is remotely manipulated using the keyboard 32 and mouse 34 of the remote-control computer 3, the lamp 151 is lit or blinks. Otherwise, characters saying “The local computer is being remotely manipulated at the remote-control computer 3.” are streamed on the LCD 152 for the purpose of notification.

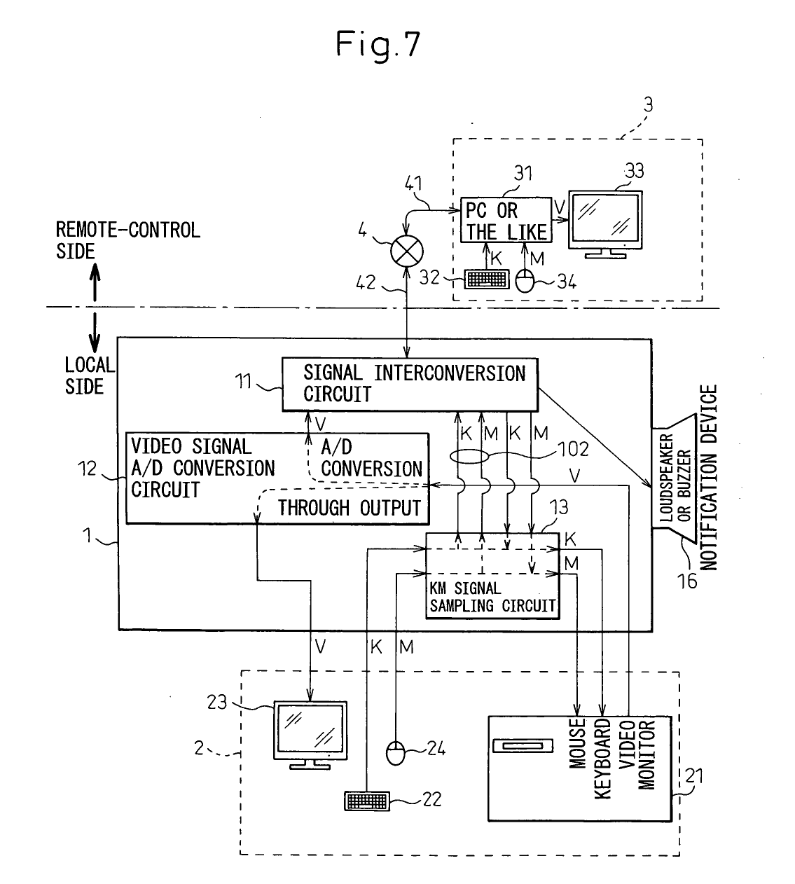

FIG. 7 is a block diagram schematically showing a sixth embodiment of a switching device in accordance with the present invention.

As shown in FIG. 7, the IP-KVM switch 1 in accordance with the sixth embodiment includes a notification device 16 such as a loudspeaker or a buzzer. The loudspeaker or buzzer 16 included in the IP-KVM switch 1 itself is used to notify the fact that the local computer 2 is being remotely manipulated at the remote-control computer 3.

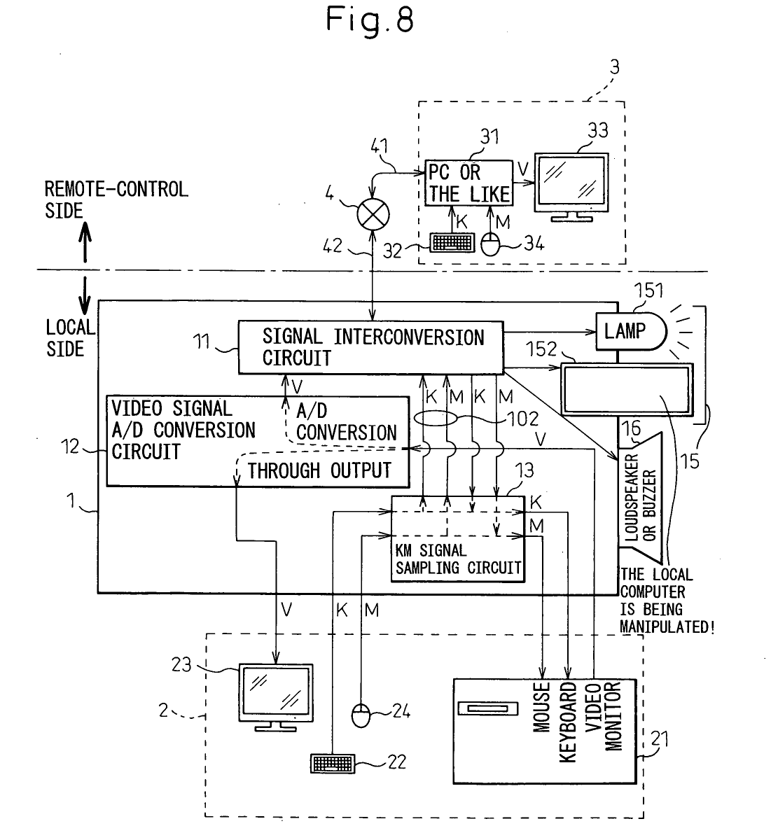

FIG. 8 is a block diagram schematically showing a seventh embodiment of a switching device in accordance with the present invention.

The seventh embodiment shown in FIG. 8 is equivalent to a combination of the fifth and sixth embodiments. The fact that the local computer 2 is being remotely manipulated at the remote-control computer 3 is notified by both the lamp 151 and LCD 152 and the loudspeaker or buzzer 16 included in the IP-KVM switch 1 itself.

Even in the fifth to seventh embodiments, lighting of the lamp 151, display of characters on the LCD 152, or sounding of the loudspeaker or buzzer 16 is controlled by the MPU or the like included in the interconversion circuit 11, and is continued for a predetermined period of time or an arbitrary period of time. Furthermore, needless to say, when the keyboard 22 or mouse 24 of the local computer 2 is manipulated, the notification by the lighting of the lamp 151, display of characters on the LCD 152, or sounding of the loudspeaker or buzzer 16 can be suspended.

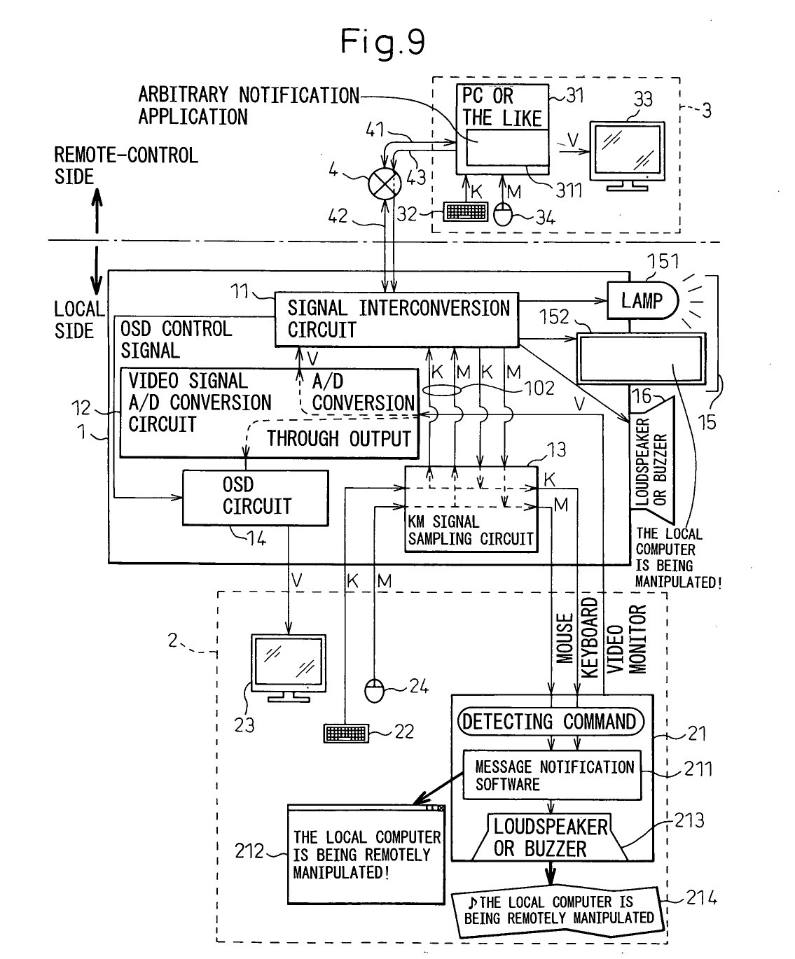

FIG. 9 is a block diagram schematically showing a seventh embodiment of a switching device in accordance with the present invention.

In the eighth embodiment shown in FIG. 9, the fact that the local computer 2 is being manipulated at the remote-control computer 3 is notified by an optimal one of the display of the message 212 such as a dialog box, the buzzer sound, music, or voice 214 radiated from the loudspeaker 213 included in the computer body 21, and the lamp 151, LCD 152, and loudspeaker or buzzer 16 included in the IP-KVM switch 1 itself.

Specifically, according to the eighth embodiment, an arbitrary notification application 311 is installed in advance in the remote-control computer 3 (computer body 31). The arbitrary notification application 311 is used to designate various settings (for example, the contents of a display message, coordinates displayed on the video monitor 23, a period of display, a period during which the lamp is lit, a pattern of blinking of the lamp, a kind of sound to be radiated, a kind of voice or music to be output). When the local side should be notified of the fact that the local computer 2 is remotely manipulated at the remote-control computer 3, the application 311 is used to transmit a command to the interconversion circuit 11 included in the IP-KVM switch over the networks 4, 43, and 44. In response to the command, the MPU or the like included in the interconversion circuit 11 controls the various pieces of notification means for the purpose of notification.

Between the remote-control computer 3 and IP-KVM switch 1, networks (4, 43, and 44) are, in addition to the networks (4, 41, and 42) over which K, V, and M signals are transferred in order to remotely manipulate the local computer 2, laid down in order to notify the local side of the fact that the local computer 2 is remotely manipulated at the remote-control computer 3.

Incidentally, the means for notifying the local side of the fact that the local computer 2 is being remotely manipulated at the remote-control computer 3 is not limited to the aforesaid ones. Other various means may be adopted.

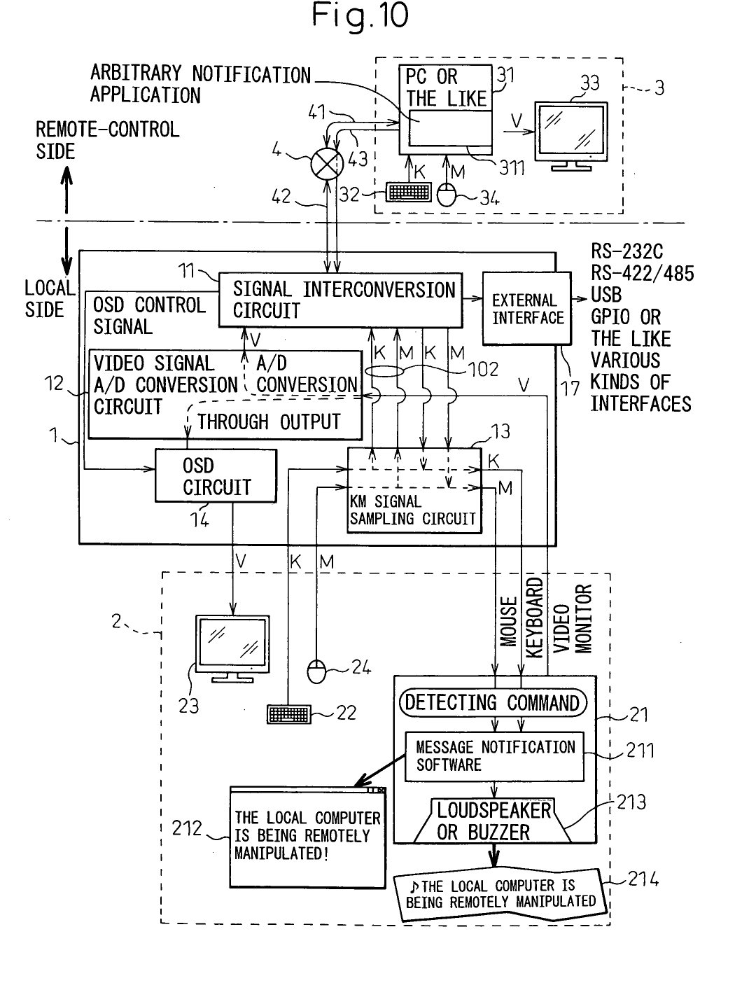

FIG. 10 is a block diagram schematically showing a ninth embodiment of a switching device in accordance with the present invention.

As shown in FIG. 10, the ninth embodiment is identical to the fourth embodiment except that the IP-KVM switch 1 is provided with an external interface 17. As the external interface 17, any of various interfaces including those conformable to the RS-232C or RS-422/485 standards and those compatible with the USB or GPIO standards can be adopted.

Cases to which the interface 17 included in the IP-KVM switch 1 is applied will be described below.

To begin with, an RS-232C interface is adopted as the interface 17 included in the IP-KVM switch 1. Lighting or flickering of a signal lamp (an alarm lamp and, for example, a Patlite®) is controlled via the RS-232C interface. This helps a user, who is at the computer to be manipulated, recognize the fact that the computer is being remotely manipulated. The signal lamp may not only be used to notify the fact that the computer is remotely manipulated but also be lit in red in order to notify an emergency. Moreover, as the signal lamp need not be grounded near the IP-KVM switch, it can be disposed in any place and to help recognize a remotely performed manipulation.

Moreover, a power tap at which, for example, an RS-232C interface is disposed may be remotely controlled via the interface 17 included in the IP-KVM switch 1. In this case, the power supply of a computer connected to the power tap can be turned on again. This would prove effective in a case where, for example, the local computer 2 is frozen. The inclusion of a general-purpose interface such as the RS-232C interface permits utilization of power taps marketed by many manufacturers.

Furthermore, a display panel including a locally procurable interface may be connected to the interface 17 included in the IP-KVM switch 1 so that any characters can be displayed on the display panel. In this case, a message can be more effectively displayed while being remotely controlled. Thus, when the display panel is included independently of the video monitor 23 of the local computer 2, it can be disposed in any place in the same manner as the aforesaid signal lamp is. Moreover, the message may be an arbitrary one and can be made more appealing.

Incidentally, apart from the interface included in the IP-KVM switch 1, contacts of a relay incorporated in the IP-KVM switch 1 may be designed to be remotely closed or opened, and the relay contacts may be provided for a user. This permits the user to turn on or off the power supplies of a siren and other devices at his/her own choice. Specifically, the contacts of the relay incorporated in the IP-KVM switch 1 permit a user to control any locally procurable devices or self-made devices. This leads to an expansion of the range of applications.

Incidentally, currently prevailing portable cellular phones can be controlled via an RS-232C interface. For example, when the RS-232C interface and an audio output circuit are incorporated in the IP-KVM switch 1, a portable cellular phone connected to the IP-KVM switch 1 is used to call a specific telephone number. A message may be displayed on the video monitor 23 of the local computer 2 connected to the IP-KVM switch 1 so that a manager or the like can be notified of the message.

Consequently, in case a server becomes abnormal, it can be indicated with a sound. Normally, a user at a remote place can use his/her portable cellular phone to call directly to a specific telephone number as long as the user and a called side stay within the same country. Assuming that a company is doing business worldwide, the languages (English, French, Portuguese, etc.) spoken in sites (where the IP-KVM switch is installed) should be employed. Once a prototypic message is registered in the languages spoken in the sites, the message is transmitted in the form of an oral message by an audio output circuit incorporated in the IP-KVM switch 1. Thus, the message can be readily communicated to operators or the like in remote places.

The aforesaid cases are mere examples. Once the IP-KVM switch 1 is provided with a general-purpose interface, it can be applied to various usages. Namely, as a general-purpose interface (17) included in the IP-KVM switch 1 permits input and output, a user having purchased the IP-KVM switch can uniquely expand the IP-KVM switch.

The present invention can be widely adapted to a switching device that makes it possible to remotely manipulate a computer, which is installed on a local side, at a remote-control side over networks. Using the switching device in accordance with the present invention, for example, an operator on the local side can be notified of the fact that the local computer such as a server connected on a network is being remotely manipulated at the remote-control computer. Consequently, the reliability of remote manipulation can be improved and the number of malfunctions can be minimized.

Many different embodiments of the present invention may be constructed without departing from the scope of the present invention, and it should be understood that the present invention is not limited to the specific embodiments described in this specification, except as defined in the appended claims.

What is claimed is:

1. A switching device making it possible to manipulate a computer, which is installed on a local side, at a remote-control side over networks, comprising:
a remote manipulation notification unit, when said computer is manipulated at the remote-control side, notifying the local side, on which said computer is installed, of the manipulation of said computer performed at the remote-control side.

2. The switching device as claimed in claim 1, wherein said remote manipulation notification unit includes a first displaying notification portion notifying the manipulation of said computer, which is performed at the remote-control side, using a display screen of a display device included in said computer.

3. The switching device as claimed in claim 2, wherein said first displaying notification portion notifies the manipulation of said computer, which is performed at the remote-control side, using characters or an image through on-screen display on said display screen of said computer.

4. The switching device as claimed in claim 2, wherein said first displaying notification portion notifies the manipulation of said computer, which is performed at the remote-control side, by displaying a dialog box or the like on said display screen of said computer.

5. The switching device as claimed in claim 1, wherein said remote manipulation notification unit includes a first sounding notification portion notifying the manipulation of said computer, which is performed at the remote-control side, using a sounding body included in said computer.

6. The switching device as claimed in claim 5, wherein said first sounding notification portion notifies the manipulation of said computer, which is performed at the remote-control side, using music or voice output from a buzzer or a loudspeaker included in a computer body.

7. The switching device as claimed in claim 1, wherein said remote manipulation notification unit includes:
a first displaying notification portion notifying the manipulation of said computer, which is performed at the remote-control side, using a display screen of a display device included in said computer; and
a first sounding notification portion notifying the manipulation of said computer, which is performed at the remote-control side, using a sounding body included in said computer.

8. The switching device as claimed in claim 1, wherein said remote manipulation notification unit includes a second displaying notification portion notifying the manipulation of said computer, which is performed at the remote-control side, using a display unit included in said switching device.

9. The switching device as claimed in claim 8, wherein said second display notification portion has a lamp or an LCD included in said switching device.

10. The switching device as claimed in claim 1, wherein said remote manipulation notification unit includes a second sounding notification portion notifying the manipulation of said computer, which is performed at the remote-control side, using a sounding body included in said switching device.

11. The switching device as claimed in claim 10, wherein said second sounding notification portion has a buzzer or a loudspeaker included in said switching device.

12. The switching device as claimed in claim 1, wherein said remote manipulation notification unit includes:
a second displaying notification portion notifying the manipulation of said computer, which is performed at the remote-control side, using a display unit included in said switching device; and
a second sounding notification portion notifying the manipulation of said computer, which is performed at the remote-control side, using a sounding body included in said switching device.

13. The switching device as claimed in claim 1, wherein said remote manipulation notification unit includes:
a first displaying notification portion notifying the manipulation of said computer, which is performed at the remote-control side, using a display screen of a display device included in said computer;
a first sounding notification portion notifying the manipulation of said computer, which is performed at the remote-control side, using a sounding body included in said computer;
a second displaying notification portion notifying the manipulation of said computer, which is performed at the remote-control side, using a display unit included in said switching device; and
a second sounding notification portion notifying the manipulation of said computer, which is performed at the remote-control side, using a sounding body included in said switching device.

14. The switching device as claimed in claim 1, wherein said remote manipulation notification unit includes an interface via which the manipulation of said computer performed at the remote-control side is communicated to each of said switching device and a notification device located outside said computer.

15. The switching device as claimed in claim 14, wherein said notification device notifies the manipulation of said computer, which is performed at the remote-control side, by lighting or blinking a signal lamp, which is disposed on the local side, via said interface included in said switching device.

16. The switching device as claimed in claim 14, wherein said notification device notifies the manipulation of said computer, which is performed at the remote-control side, using a portable cellular phone, which is disposed on the local side, via said interface included in said switching device.

17. The switching device as claimed in claim 14, wherein a power supply of said computer is controlled by manipulating the power supply at the remote-control side via said interface.

18. The switching device as claimed in claim 1, wherein said remote manipulation notification unit notifies the manipulation of said computer, which is performed at the remote-control side, during a predetermined period of time or an arbitrary period of time.

19. The switching device as claimed in claim 18, wherein when said computer is manipulated at the local side, said remote manipulation notification unit suspends a notification of the manipulation of said computer performed at the remote-control side.

20. The switching device as claimed in claim 1, wherein said networks are IP networks and said switching device is an IP-KVM switch.

21. A control method for a switching device making it possible to manipulate a computer, which is installed on a local side, from a remote-control side via networks, wherein:
when said computer is manipulated at the remote-control side, the local side on which said computer is installed is notified of the manipulation of said computer performed at the remote-control side.

22. A control program for a switching device that makes it possible to manipulate a computer, which is installed on a local side, from a remote-control side over networks, and that when said computer is manipulated at the remote-control side, notifies the local side, on which said computer is installed, of the manipulation of said computer performed at the remote-control side, wherein:
said control program makes said computer to notify the manipulation of said computer, which is performed from the remote-control side, using a display screen of a display device included in said computer or by outputting a sound from said computer.
